(19) United States
(12) Patent Application Publication
(10) Pub. No.: US 2016/0030960 A1
(43) Pub. Date: Feb. 4, 2016

(54) SPRAY GUN MANUFACTURING METHOD, SPRAY GUN, SPRAY GUN BODY AND COVER

(71) Applicant: SATA GmbH & Co. KG, Kornwestheim (DE)

(72) Inventor: Ralf GEHRUNG, Stuttgart (DE)

(21) Appl. No.: 14/815,210

(22) Filed: Jul. 31, 2015

(30) Foreign Application Priority Data
Jul. 31, 2014 (CN) 201410374583.4

(51) Int. Cl. B05B 11/00; B05B 15/00

(52) U.S. Cl. CPC B05B 11/0005; B05B 15/00

(57) ABSTRACT

A spray gun manufacturing method, a spray gun, a spray gun body and a cover. The method includes forming a spray gun body. In forming the spray gun body, a bearing part is formed on a side of the spray gun body, with a surface of the bearing part being lower than another surface of the side of the spray gun body, and a partial edge of the bearing part corresponding to a partial edge of the spray gun body.

### FIELD OF THE INVENTION

The present invention relates to a spray gun body manufacturing method, a spray gun body, and a cover for a digital pressure measurement device, which cover has an edge of part of a spray gun.

### BACKGROUND

The spray gun is a tool that is commonly used in industry, which can for example spray coatings onto article surfaces, e.g. furniture, machinery and especially vehicles.

Moreover, as technology has progressed, a spray gun 1 with a digital pressure measurement device 31 provided on a handgrip 21 has appeared. FIG. 2 shows a spray gun 1 with a digital pressure measurement device 31 provided on a handgrip 21. Compared with a spray gun that is not provided with a digital pressure measurement device (as shown in FIG. 1), the handgrip 21 of the spray gun 1 provided with the digital pressure measurement device 31 is wider, so that the digital pressure measurement device has enough space in the handgrip. This has given rise to a new technical problem.

A spray gun manufacturer must produce two different types of spray gun body; one type has a wider handgrip (digital type), while the other type has a smaller handgrip (standard type). As a result, the manufacturer requires two different types of forging tool or casting tool. These tools are very expensive, leading to high costs. Furthermore, before producing spray gun bodies, the manufacturer must know how many standard spray guns and how many digital spray guns it requires. In addition, the spray gun user must accustom himself to two different types of spray gun handgrip. If a customer is accustomed to using a standard spray gun for work, and wishes to switch to a digital spray gun, he must first become familiar with the digital spray gun, as the digital spray gun is placed differently in the hand. Moreover, since the handgrip of the digital spray gun is very wide, the user must spread his hand very wide when gripping the spray gun in his hand. When the user needs to work with the spray gun for a long period of time, this is tiring for the user.

### SUMMARY OF THE INVENTION

A manufacturing method for a spray gun is disclosed, which method allows the same tools (especially casting or forging tools) to be used to produce digital spray guns and standard spray guns; this makes the manufacturing method cheaper and more flexible.

Also disclosed is a body of a spray gun, by means of which spray gun a digital handgrip and a standard handgrip have the same width.

Further disclosed is a spray gun by means of which a digital handgrip and a standard handgrip have the same width.

In addition, a cover for a digital pressure measurement device is disclosed, which cover has a partial edge of a spray gun (in particular a handgrip of a spray gun body).

According to one aspect of the present invention, a method for manufacturing a spray gun is provided, comprising a step of forming a spray gun body. In the step of forming the spray gun body, a bearing part is formed on a side of the spray gun body, with a surface of the bearing part being lower than another surface of the side of the spray gun body, and a partial edge of the bearing part corresponding to a partial edge of the spray gun body.

Preferably, the method further comprises covering the bearing part with a cover, wherein a partial edge of the cover corresponds to the partial edge of the spray gun body.

Preferably, the bearing part is formed on a side of a handgrip of the spray gun body.

Preferably, the method further comprises a step of forming a slot in the bearing part, to hold a digital pressure measurement device.

Preferably, a digital pressure measurement device is formed on the cover.

Preferably, the cover and the spray gun body form a shadow gap.

Preferably, the shadow gap is formed by a step part close to an edge of the cover.

Preferably, the shadow gap is formed by a step part close to an edge of the spray gun body.

Preferably, the shadow gap is formed simultaneously by a step part close to an edge of the cover and a step part close to an edge of the spray gun body.

Preferably, the cover can be removably attached to the spray gun body by means of at least one projection and at least one corresponding hole.

Preferably, the cover has two projections, and the spray gun body has two corresponding holes.

Preferably, the spray gun body has two projections, and the cover has two corresponding holes.

Preferably, the cover has one projection and one corresponding hole, while the spray gun body has one projection and one corresponding hole.

Preferably, the cover has at least one slot.

Preferably, the cover has a window arranged in the slot.

Preferably, the window is covered by a transparent protective plate.

According to another aspect of the present invention, a method for manufacturing a spray gun with a digital pressure measurement device attached is provided, the method comprising a step of manufacturing a spray gun body without a digital pressure measurement device.

Preferably, the method further comprises forming a bearing part on a side of the spray gun body by cutting; a surface of the bearing part is lower than another surface of the side of the spray gun body.

Preferably, a partial edge of the bearing part corresponds to a partial edge of the spray gun body.

Preferably, the bearing part is formed on a side of a handgrip of the spray gun body; and a partial edge of the bearing part corresponds to a partial edge of the handgrip of the spray gun body.

Preferably, the method further comprises forming a slot in the bearing part by cutting in order to hold a digital pressure measurement device.

Preferably, the method further comprises placing the digital pressure measurement device in the slot.

Preferably, the method further comprises covering the bearing part with a cover, wherein a partial edge of the cover corresponds to the partial edge of the spray gun body.

According to another aspect of the present invention, a spray gun body is provided, comprising a handgrip, wherein a bearing part is formed on a side of the spray gun body, with a surface of the bearing part being lower than another surface of the spray gun body side, and a partial edge of the bearing part corresponding to a partial edge of the spray gun body.

According to another aspect of the present invention, a spray gun is provided, comprising a spray gun body, wherein a bearing part is formed on a side of the spray gun body, with a surface of the bearing part being lower than another surface of the side of the spray gun body, and a partial edge of the bearing part corresponding to a partial edge of the spray gun body.

According to another aspect of the present invention, a cover for a spray gun is provided, wherein at least a partial edge of the cover corresponds to a partial edge of a spray gun body.

According to yet another aspect of the present invention, a spray gun comprises a frame body defining a recessed bearing surface forming a first portion of a leading edge of a handgrip; a first cover shaped and dimensioned to fit into the recessed bearing surface and to form a second portion of the leading edge of the handgrip, and a side portion of the handgrip; and a second cover shaped and dimensioned to fit into the recessed bearing surface and to form a second portion of the leading edge of the handgrip, and a side portion of the handgrip. The second cover further includes a recess bounded in part by the second portion of the leading edge of the handgrip, the recess sized and dimensioned to at least partially receive a digital pressure measurement device, and a window formed within the side portion of the handgrip that is sized and dimensioned to enable viewing of a display of the digital pressure measurement device when a digital pressure measurement device is received within the recess. The first cover is connectable to the frame body when a digital pressure measurement device is not installed in the spray gun, and the side portion of the handgrip of the first cover does not include a display window. The second cover is connectable to the frame body when a digital pressure measurement device is installed in the spray gun. The exterior dimensions of the handgrip are substantially the same when either the first or second cover is connected to the frame.

### BRIEF DESCRIPTION OF THE DRAWINGS

FIG. 1 shows a spray gun in which no digital pressure measurement device is provided on the handgrip in the prior art;

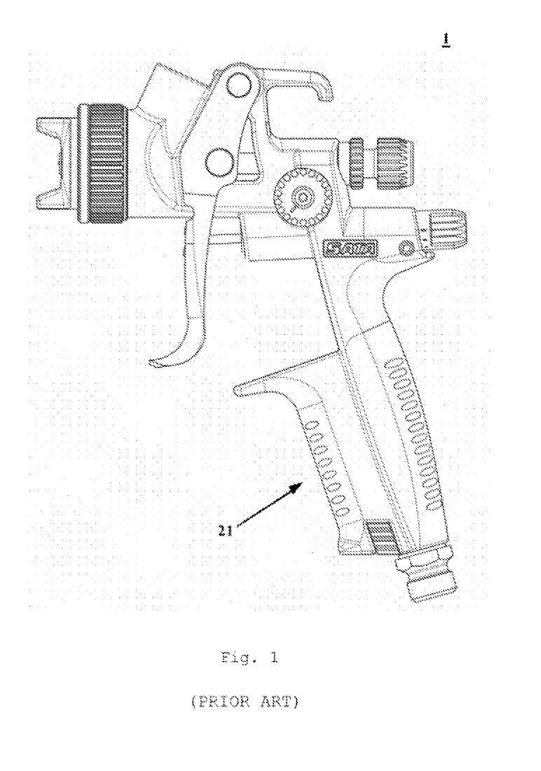

FIG. 2 shows a spray gun in which a digital pressure measurement device is provided on the handgrip in the prior art;

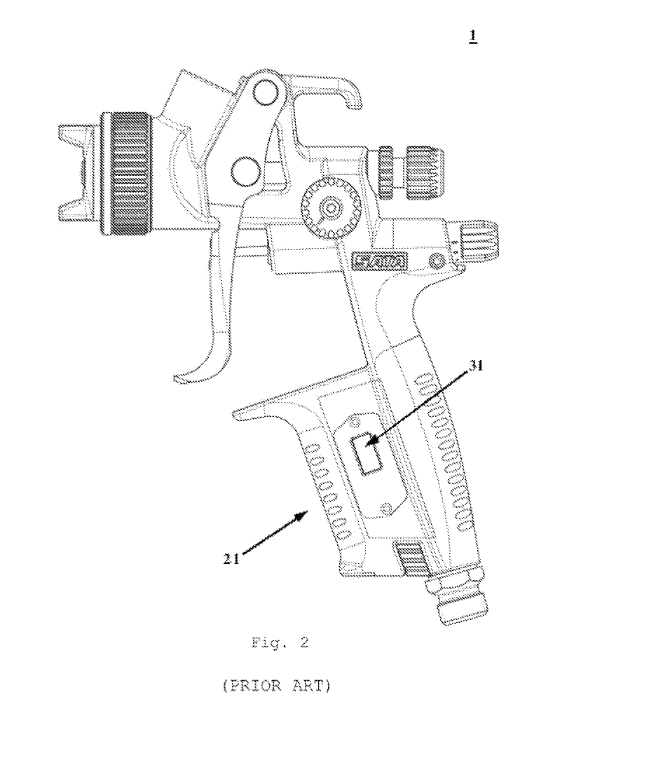

FIG. 3 shows a spray gun body and cover according to embodiment one of the present invention;

FIG. 4 shows a spray gun in which no digital pressure measurement device is provided according to the present invention;

FIG. 5 shows a spray gun in which a digital pressure measurement device is provided according to the present invention;

FIG. 6 shows a spray gun body and cover according to embodiment two of the present invention;

FIG. 7A shows a front view and FIG. 7B shows perspective view of a cover according to embodiment three of the present invention;

FIG. 8 shows a spray gun according to embodiment four of the present invention.

### DETAILED DESCRIPTION OF EMBODIMENTS OF THE INVENTION

In the following detailed description, the accompanying drawings which form part of this description are referred to, wherein particular embodiments capable of realizing the present invention are shown by way of example. With regard to the drawings, directional terms such as “top”, “bottom”, “inner” and “outer” are used with reference to the direction of the drawing described. Since the components of the embodiments of the present invention can be placed in many different directions, directional terms are merely used for illustration, without having any limiting meaning. It should be understood that other embodiments may be used, and structural or logic changes may be made on condition that the scope of the present invention is not departed from. Thus, the detailed description below should not be understood as having a limiting meaning, and the present invention shall be defined by the attached claims.

### Embodiment One

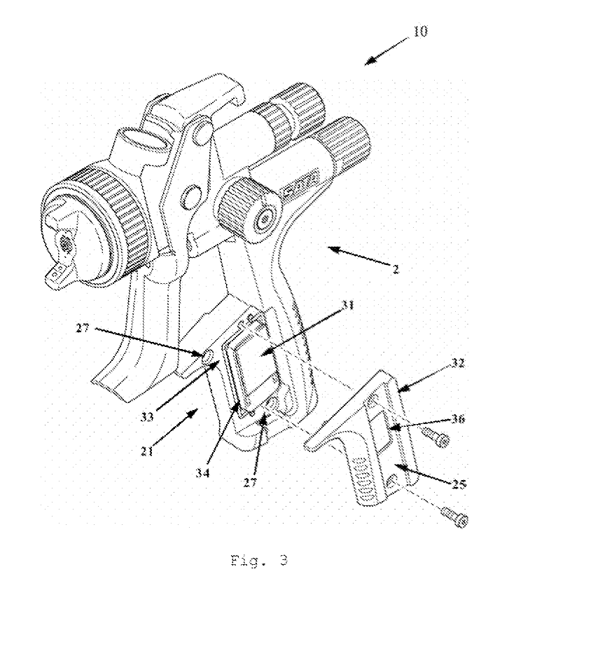

A method for manufacturing a spray gun according to embodiment one of the present invention is explained with reference to FIG. 3.

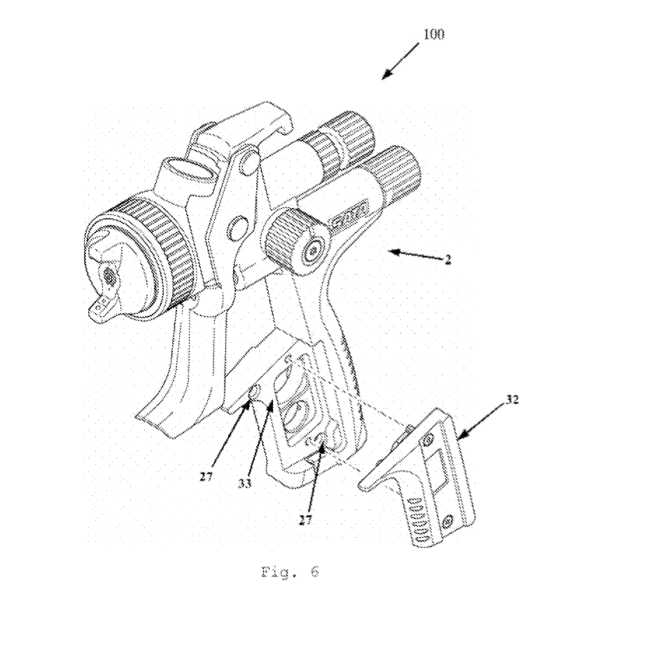

As FIG. 3 shows, a body 2 for a spray gun 10 of the present invention is formed by a forging or casting method, with the formed body 2 having, formed on a handgrip 21, a bearing part 33 for bearing a cover 32. Moreover, referring further to FIG. 3, a surface of the bearing part 33 is lower than another surface of the handgrip 21, and a partial edge of the bearing part 33 corresponds to a partial edge of the spray gun body 2. Furthermore, a slot 34 for holding a digital pressure measurement device 31 is formed by cutting in the surface of the bearing part 33 of the body 2. As can be seen by referring to FIG. 6, in at least one region, the slot 34 may run through the entire width (from one side to the other side) of the handgrip. One benefit of such a design is to enable a hole for holding a battery to be reached without removing the cover 32 and the digital pressure measurement device 31. Thus, the hole for holding the battery can be opened by a screw at another of the handgrip, and the battery can be replaced when the hole is empty.

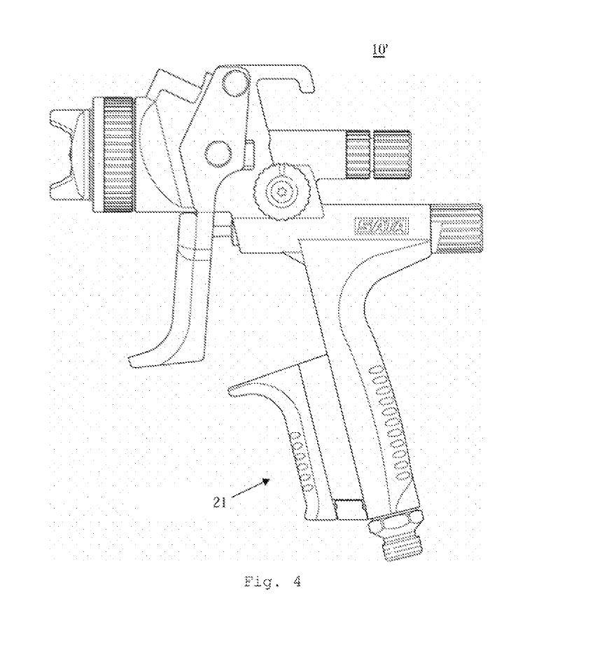

Furthermore, referring further to FIG. 3, the manufacturing method of embodiment one of the present invention also comprises forming the cover 32, for covering the digital pressure measurement device 31. Referring to FIG. 3, a partial edge of the cover 32 corresponds to that partial edge of the bearing part 33 which corresponds to a partial edge of the handgrip 21. That is, once the cover 32 has been installed on the bearing part 33, a partial edge of the cover 32 and a partial edge of the bearing part 33 coincide, together forming a partial edge of the handgrip 21. In the prior art, a cover of the digital pressure measurement device is located in a middle part of the spray gun handgrip, and surrounded by the handgrip, thereby being isolated from the edge of the handgrip. Thus, a frame or edge is needed to surround the cover for the digital pressure measurement device, and an edge of the spray gun handgrip is needed. These two edges both need space, so the handgrip must be made wider from front to back (relative to a spray gun with no digital pressure measurement device) in order to provide enough space. By way of the present invention, the edge of the cover for the digital pressure measurement device is the same as the edge of the handgrip. Thus, a part of the edge of the handgrip of the spray gun 10 is integrally formed in the cover 32, so that there is no need for an additional outer edge formed by the spray gun body. Thus, the space needed for an outer edge is saved. Thus, if a digital pressure measurement device is arranged in the spray gun handgrip, the handgrip can be manufactured with a smaller size (see FIG. 4).

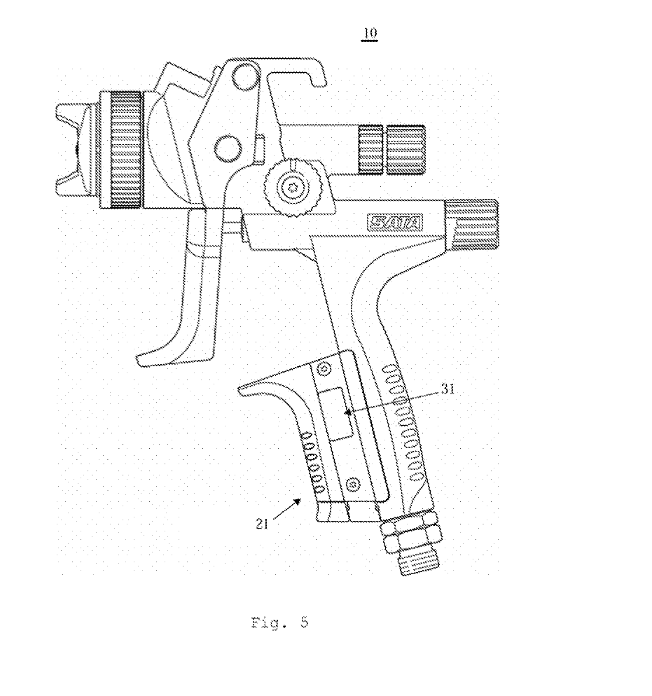

Furthermore, since the spray gun handgrip provided with a digital pressure measurement device can be manufactured with a smaller size, the method of embodiment one only needs to produce one type of spray gun body, which can then be used for standard spray guns 10′ and digital spray guns 10 (see FIGS. 4 and 5). In the process according to the present invention, a manufacturer can first form standard spray gun bodies with intact handgrips, then decide how many spray gun bodies for use in digital spray guns it needs to then manufacture. Holes and slots are cut in these spray gun bodies, to enable them to receive components for a digital pressure measurement device.

Moreover, since a digital spray gun of a width equal to that of a standard spray gun can be manufactured, a user does not need to accustom himself to two different types of spray gun handgrip, therefore the user experience is also enhanced.

Moreover, preferably, referring further to FIG. 3, a slot 25 is provided in the cover 32, and a window 36 is provided in the slot 25, the window being covered by a transparent protective plate. Due to the presence of the slot, the position of the protective plate is further lowered relative to the outer surface of the cover, thereby further protecting the protective plate from impacts from other objects. In addition, the slot can also achieve the objective of saving material. Moreover, the provision of the slot enables the handgrip to be more ergonomic. Since the user's fingers will bend at the front edge of the handgrip 21 when the user grips the handgrip, the user's fingers will wrap round the front edge of the handgrip 21. Since the slot 25 is provided on the handgrip, protruding parts of the user's fingers can be laid in the slot 25 when the user's fingers have wrapped round the front edge of the handgrip 21, thereby preventing the user's fingers from being squeezed with the user's palm after wrapping round the handgrip front edge. Thus the comfort and stability of gripping are enhanced. The slot 25 may also be formed on another side of the spray gun and may also be formed on the handgrip of a spray gun with no digital pressure measurement device.

Furthermore, preferably, referring further to FIG. 3, the cover 32 covers the digital pressure measuring gauge 31 installed on the handgrip 21. The slot 25 is disposed in the cover 32, and a window 33 is provided in the slot 25, the window being covered by a transparent protective plate; the transparent protective plate may for example be bonded on the inside of the window.

### Embodiment Two

Embodiment two of the present invention is explained with reference to FIG. 6.

All other technical features of embodiment two of the present invention are the same as in embodiment one, so are not repeated here. Embodiment two differs from embodiment one in that the digital pressure measurement device 31 is formed in the cover 32. The digital pressure measurement device 31 is installed in the handgrip of spray gun 100 by installing the cover 32 on the bearing part 33 of the handgrip 21.

As shown in FIG. 6 and mentioned above, the slot in the bearing part may run through the entire width (from one side to the other side) of the handgrip, so that a hole holding a battery is accessible on the other side of the handgrip. This through-running slot is preferably a drilled hole. A blind hole may be provided beside and separate from the through-running drilled hole, so as to be used for holding a pressure sensor. The blind hole is connected to a gas passage in the spray gun, so that the pressure sensor can measure the pressure in the gas passage. Above the drilled hole, a substantially rectangular slot may be formed for holding a circuit board having a display of the digital pressure measurement device.

### Embodiment Three

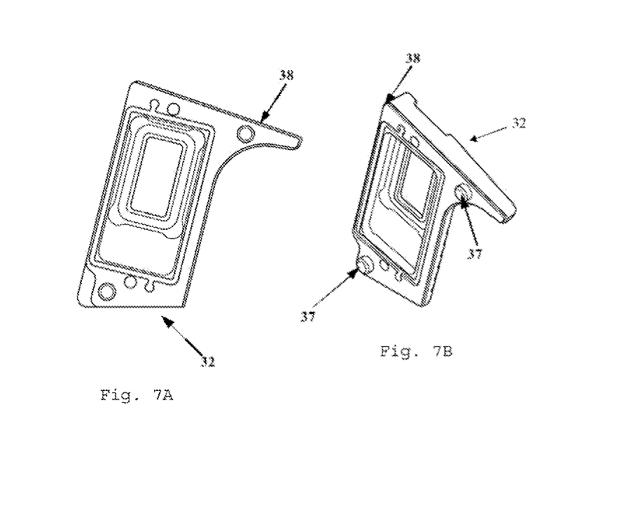

Embodiment three of the present invention is explained below with reference to FIG. 7.

Information about all other technical features of embodiment three of the present invention can be found by referring to embodiment one and embodiment two, so is not repeated.

Referring to FIGS. 7A and 7B, the cover 32 has at least one positioning or retaining projection 37, and the bearing part 33 has a hole 27 (FIGS. 3 and 6) for receiving the projection 37; the cover can be removably attached to the spray gun body by means of the at least one projection and the at least one corresponding hole. Thus, if the spray gun falls and the cover strikes the floor, the impact force will not be completely guided to a screw for fixing the cover to the spray gun body; rather, most of the impact force is absorbed by the projection, thereby protecting the screw. The projection can be manufactured to be thicker than the screw, and therefore more sturdy and durable. Alternatively, the spray gun body has a projection, while the cover has a corresponding hole.

Preferably, there are two of said projections.

As can be seen in FIGS. 7A and 7B, the cover 32 also has a slot which holds the digital pressure measurement device. Thus, it is by no means the case that the entire device must be included in the handgrip; it can be sandwiched between the handgrip and the cover and thereby extend into the handgrip and the cover. Thus, the handgrip can be made thinner.

A sealing ring with an attached fixing element is provided in the cover, in order to seal the digital pressure measurement device so it is isolated from the external environment, and pollution by dust, solvents or spray paint is thereby avoided.

### Embodiment Four

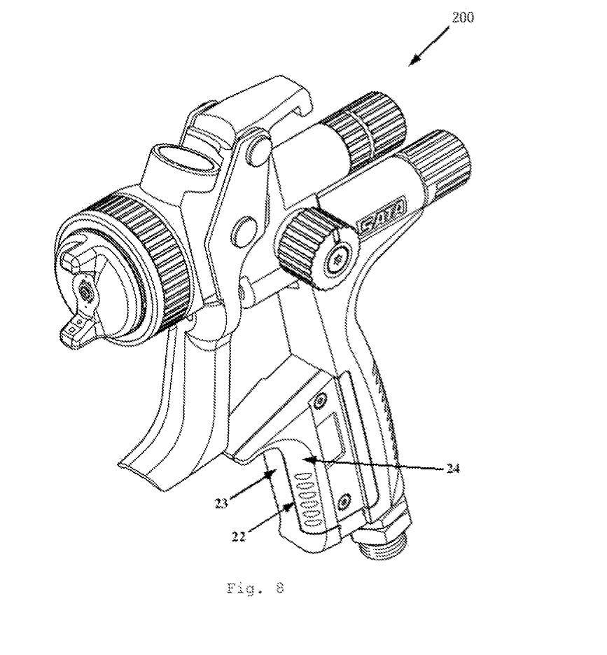

FIG. 8 shows a fourth embodiment of a spray gun having a digital pressure measurement device according to the present invention.

FIG. 8 shows a spray gun having a shadow gap of the present invention. As FIG. 8 shows, the spray gun 200 has a shadow gap 22, which maintains a certain distance between a surface 23 of the spray gun body and a surface of the cover 24 of the digital pressure measurement device, thereby concealing the error allowed during manufacture, eliminating the need for millimetre-scale precision processing, and reducing the gripping discomfort which arises when the edges of surfaces installed side by side are not flush with each other.

Furthermore, the shadow gap may be formed by a smaller step part 38 close to an edge of the cover 32 of the digital pressure measurement device, as FIGS. 7A and 7B show. The cover 32 forms an edge of the spray gun, and the cover 32 has at least one shadow gap; when a surface having a shadow gap is installed side by side with another surface, the shadow gap can give rise to a boundary part for permitting a certain error, thereby eliminating the need for millimetre-scale precision processing.

In addition, the shadow gap may also be formed by a smaller step part close to an outer edge of the spray gun body to be fitted with the cover, or formed simultaneously by a smaller step part close to an edge of the cover of the digital pressure measurement device and a smaller step part close to an outer edge of the spray gun body to be fitted with the cover.

In addition, the shadow gap may also be formed by another form besides a step part.

The above embodiments are merely preferred embodiments of the present invention, which are not intended to limit it. To those skilled in the art, various changes and alterations to the present invention are possible. Any amendments, equivalent substitutions or improvements etc. made within the spirit and principles of the present invention should be included in the scope of protection thereof.

What is claimed is:

1. Method for manufacturing a spray gun, comprising a step of forming a spray gun body, wherein:
in the step of forming the spray gun body, a bearing part is formed on a side of the spray gun body, with a surface of the bearing part being lower than another surface of the side of the spray gun body, and a partial edge of the bearing part corresponding to a partial edge of the spray gun body.

2. Method for manufacturing a spray gun according to claim 1, further comprising covering the bearing part with a cover, wherein a partial edge of the cover corresponds to the partial edge of the spray gun body.

3. Method for manufacturing a spray gun according to claim 1, wherein the bearing part is formed on a side of a handgrip of the spray gun body.

4. Method for manufacturing a spray gun according to claim 1, further comprising a step of forming a slot in the bearing part, the slot configured and dimensioned to hold a digital pressure measurement device.

5. Method for manufacturing a spray gun according to claim 2, wherein a digital pressure measurement device is formed on the cover.

6. Method for manufacturing a spray gun according to claim 2, wherein the cover and the spray gun body form a shadow gap.

7. Method for manufacturing a spray gun according to claim 6, wherein the shadow gap is formed by a step part close to an edge of the cover.

8. Method for manufacturing a spray gun according to claim 6, wherein the shadow gap is formed by a step part close to an edge of the spray gun body.

9. Method for manufacturing a spray gun according to claim 6, wherein the shadow gap is formed simultaneously by a step part close to an edge of the cover and a step part close to an edge of the spray gun body.

10. Method for manufacturing a spray gun according to claim 2, wherein the cover can be removably attached to the spray gun body by at least one projection in one of the spray gun body and cover and at least one corresponding hole in the other of the spray gun body and cover.

11. Method for manufacturing a spray gun according to claim 10, wherein the cover has two projections, and the spray gun body has two corresponding holes.

12. Method for manufacturing a spray gun according to claim 10, wherein the spray gun body has two projections, and the cover has two corresponding holes.

13. Method for manufacturing a spray gun according to claim 10, wherein the cover has one projection and one hole, while the spray gun body has one corresponding projection and one corresponding hole.

14. Method for manufacturing a spray gun according to claim 2, wherein the cover has at least one slot.

15. Method for manufacturing a spray gun according to claim 14, wherein the cover has a window arranged in the slot.

16. Method for manufacturing a spray gun according to claim 15, wherein the window is covered by a transparent protective plate.

17. Method for manufacturing a spray gun with a digital pressure measurement device attached, wherein the method comprises a step of manufacturing a spray gun body without a digital pressure measurement device.

18. Method for manufacturing a spray gun according to claim 17, wherein the method further comprises forming a bearing part on a side of the spray gun body by cutting; a surface of the bearing part is lower than another surface of the side of the spray gun body.

19. Method for manufacturing a spray gun according to claim 18, wherein a partial edge of the bearing part corresponds to a partial edge of the spray gun body.

20. Method for manufacturing a spray gun according to claim 18, wherein the bearing part is formed on a side of a handgrip of the spray gun body; and a partial edge of the bearing part corresponds to a partial edge of the handgrip of the spray gun body.

21. Method for manufacturing a spray gun according to claim 18, wherein the method further comprises forming a slot in the bearing part by cutting, the slot configured and dimensioned for holding the digital pressure measurement device.

22. Method for manufacturing a spray gun according to claim 21, wherein the method further comprises placing the digital pressure measurement device in the slot.

23. Method for manufacturing a spray gun according to claim 22, wherein the method further comprises covering the bearing part with a cover, wherein a partial edge of the cover corresponds to the partial edge of the spray gun body.

24. Spray gun body, comprising a handgrip, wherein:
a bearing part is formed on a side of the spray gun body, with a surface of the bearing part being lower than another surface of the side of the spray gun body, and a partial edge of the bearing part corresponding to a partial edge of the spray gun body.

25. Spray gun body according to claim 24, wherein the bearing part is formed on a side of a handgrip of the spray gun body.

26. Spray gun body according to claim 24, wherein a slot is formed on a surface of the bearing part.

27. Spray gun body according to claim 24, wherein a step part is formed on an edge of the spray gun body.

28. Spray gun body according to claim 24, wherein at least one projection and/or at least one hole is formed on the bearing part surface.

29. Spray gun body according to claim 28, wherein two projections are formed on the bearing part surface.

30. Spray gun body according to claim 28, wherein two holes are formed on the bearing part surface.

31. Spray gun body according to claim 28, wherein one projection and one hole are formed on the bearing part surface.

32. Spray gun, comprising a spray gun body, wherein a bearing part is formed on a side of the spray gun body, with a surface of the bearing part being lower than another surface of the side of the spray gun body, and a partial edge of the bearing part corresponding to a partial edge of the spray gun body.

33. Spray gun according to claim 32, further comprising a cover, which covers the bearing part, wherein a partial edge of the cover corresponds to the partial edge of the spray gun body.

34. Spray gun according to claim 32, wherein the bearing part is formed on a side of a handgrip of the spray gun body.

35. Spray gun according to claim 32, wherein a slot is formed in the bearing part surface, the slot configured and dimensioned for holding a digital pressure measurement device.

36. Spray gun according to claim 33, wherein a digital pressure measurement device is formed on the cover.

37. Spray gun according to claim 33, wherein the cover and the spray gun body form a shadow gap.

38. Spray gun according to claim 37, wherein the shadow gap is formed by a step part close to an edge of the cover.

39. Spray gun according to claim 37, wherein the shadow gap is formed by a step part close to an edge of the spray gun body.

40. Spray gun according to claim 37, wherein the shadow gap is formed by both a step part close to an edge of the cover and a step part close to an edge of the spray gun body.

41. Spray gun according to claim 33, wherein the cover can be removably attached to the spray gun body by at least one projection on one of the spray gun body and cover and at least one corresponding hole on the other of the spray gun body and cover.

42. Spray gun according to claim 41, wherein the cover has two projections, and the spray gun body has two corresponding holes.

43. Spray gun according to claim 41, wherein the spray gun body has two projections, and the cover has two corresponding holes.

44. Spray gun according to claim 41, wherein the cover has one projection and one hole, while the spray gun body has one corresponding hole and one corresponding projection.

45. Spray gun according to claim 33, wherein the cover has at least one slot.

46. Spray gun according to claim 45, wherein the cover has a window arranged in the slot.

47. Spray gun according to claim 46, wherein the window is covered by a transparent protective plate.

48. Cover for a spray gun having a spray gun body, wherein at least a partial edge of the cover corresponds to a partial edge of the spray gun body.

49. Cover according to claim 48, wherein at least a partial edge of the cover corresponds to a partial edge of a handgrip of the spray gun body.

50. Cover according to claim 48, wherein a digital pressure measurement device is formed on the cover.

51. Cover according to claim 48, wherein a step is formed on an edge of the cover, such that the cover and the spray gun body form a shadow gap.

52. Cover according to claim 48, wherein the cover has at least one projection and/or at least one hole, such that the cover can be removably attached to the spray gun body by the projection and/or the hole.
